(19) United States
(12) Patent Application Publication
(10) Pub. No.: US 2022/0226878 A1
(43) Pub. Date: Jul. 21, 2022

(54) ROBOT GRIPPER, INDUSTRIAL ROBOT, HANDLING SYSTEM AND METHOD FOR REMOVING PLATE-SHAPED WORKPIECES FROM A STACK

(71) Applicant: HOMAG Automation GmbH, Lichtenberg (DE)

(72) Inventors: Jens LUDWIG, Oberschöna (DE); Stefan BRUSKY, Lichtenberg (DE); Dominik ZILLER, Oberschöna (DE)

(21) Appl. No.: 17/611,557

(22) PCT Filed: May 13, 2020
(86) PCT No.: PCT/EP2020/063297

§ 371 Date: Nov. 15, 2021

(30) Foreign Application Priority Data
May 16, 2019 (DE) 10 2019 112 867.6

(51) Int. Cl. B21D 43/10; B21D 43/18; B21D 43/24; B25J 13/08; B25J 15/00; B25J 15/06; B25J 19/02; B25J 9/16; B65G 47/91; B65G 61/00; B65G 59/04

(52) U.S. Cl. CPC B21D 43/105; B21D 43/18; B21D 43/24; B25J 13/085; B25J 15/0052; B25J 15/0616; B65G 2201/0282; B25J 9/1697; B65G 47/918; B65G 61/00; B65G 59/04; B65G 2201/022; B25J 19/021

(57) ABSTRACT

What is disclosed is a robot gripper having a receiving area which is configured to be connected to an industrial robot, and having at least one suction unit which is configured to be connected to a vacuum source. The suction unit comprises a suction surface on which a preferably plate-shaped workpiece, which preferably consists at least in sections of wood, wood materials, plastic, aluminum or the like, can be held by means of negative pressure. The suction unit comprises a substantially straight pressing edge in an edge section. The robot gripper further comprises an actuator configured to tilt the suction unit about a first tilt axis relative to the receiving area.

### TECHNICAL FIELD

The invention relates to a robot gripper configured to be connected to an industrial robot. Moreover, the invention relates to an industrial robot with this gripper, and to a handling system comprising this industrial robot. In addition, the invention relates to a method for removing plate-shaped workpieces, which preferably consist at least in sections of wood, wood materials, plastic, aluminum or the like, from a stack.

### PRIOR ART

In the furniture and components industry, an increase in demand for individualized products is currently apparent. For example, end consumers are increasingly buying furniture items that are customized to the dimensions of a specific room, or that feature a particular color and/or material combination. Despite a high degree of individualization and the associated small batch size, such products can be manufactured on an industrial scale.

In the case of a piece of furniture, for example, it is conceivable to first prepare all the required plates and then stack them on a storage device. Since a piece of furniture usually consists of a large number of various plates, the prepared plates that are stacked on the storage device mostly form an uneven stack. An uneven stack, also referred to as chaotic stack, has individual layers, the composition and/or arrangement of which differs. As shown in FIG. 1, a chaotic stack 210 on a storage device 200 may comprise workpieces 220b lying in an edge section of the chaotic stack 210. Moreover, a chaotic stack 210 may comprise workpieces 220a lying in a central section of the chaotic stack 210. In addition, it is clear that the workpieces 220 of the chaotic stack 210 may have different dimensions.

In order to remove parts from a chaotic stack in an automated manner (i.e. to separate plates), industrial robots, e.g. gantry robots or six-axis robots, with suction grippers can be used. A suction gripper is configured to pick up and hold objects by negative pressure. It has been shown, however, that individual, in particular individual superimposed plates, are difficult to separate due to adhesion effects or other surface adhesion effects. Specifically, when lifting one plate, there is the risk of also lifting the plate underneath. This effect is intensified if the workpieces to be sucked have a certain porosity, i.e. pass on the negative pressure of the gripper at least in part to plates underneath.

In order to nevertheless be able to remove an individual plate from a chaotic stack, it has proven useful to push the plate to be removed off the plate underneath using a suction gripper. The plate to be removed is usually displaced parallel to the top surface of the plate underneath. However, with this method, the plates lying in an edge section of the chaotic stack must first be removed. Only after these outer plates have been removed is there sufficient space to also remove the inner plates by displacement. Therefore, a removal sequence is specified which does not necessarily correspond to the optimal sequence.

### DESCRIPTION OF THE INVENTION

The object of the invention is to provide a simple and efficient possibility for removing plate-shaped workpieces from a stack.

According to the invention, this object is solved by a robot gripper according to claim 1, an industrial robot according to claim 14, a method according to claim 15, and a handling system according to claim 21. Preferred embodiments are specified in the subclaims.

A robot gripper according to the invention comprises a receiving area configured to be connected to an industrial robot. Moreover, the robot gripper comprises at least one suction unit configured to be connected to a vacuum source. The suction unit comprises a suction surface on which a preferably plate-shaped workpiece, preferably consisting at least in sections of wood, wood materials, plastic, aluminum or the like, can be held by negative pressure. In addition, the robot gripper comprises a substantially straight pressing edge in an edge section. A robot gripper according to the invention moreover comprises an actuator that is configured to tilt the suction unit about a first tilt axis relative to the receiving area.

In the present context, an industrial robot is a device that is suitable for picking up a workpiece, changing its position and laying down the workpiece. An industrial robot may be, for example, a six-axis robot, a linear robot, a gantry robot, a robot with parallel kinematics, or a comparable device.

A suction unit can be configured, for example, as a suction box or as a plurality of suction cups. For example, a suction box can be configured substantially cuboid in shape. A suction surface can e.g. be a surface of a suction box which has openings. However, a suction surface can also be a virtual surface that is defined by a plurality of suction cups.

An actuator can be, for example, a linear motor, a spindle drive, a hydraulically or pneumatically operable cylinder, or a magnetically operable actuator;

A robot gripper according to the invention advantageously makes it possible to apply a method in which even centrally arranged plates of a chaotic stack can be removed from the chaotic stack without first having to remove plates arranged in edge sections of the chaotic stack. For this purpose, the gripper according to the invention can first be moved by an industrial robot into the vicinity of a workpiece to be removed which lies on a chaotic stack. The workpiece to be removed can be a plate-shaped workpiece, for example, which lies in the uppermost stack layer of a chaotic stack in a central section of the chaotic stack. The suction unit can then be tilted such that the suction surface assumes an angle relative to the workpiece to be removed, e.g. an angle of between 1° and 2° inclusive. Furthermore, the robot gripper can be moved such that the pressing edge of the robot gripper lies substantially on an edge of the workpiece to be removed. The suction unit and the workpiece to be removed may enclose a substantially wedge-shaped gap in this state. If a negative pressure is applied to the suction unit in this state, the workpiece lying under the robot gripper can be pulled to the suction surface of the suction unit without another workpiece lying underneath adhering to the pulled workpiece. During pulling, the workpiece substantially performs a tilting movement towards the suction surface. The pressing edge of the robot gripper can be regarded as the tilt axis with respect to the tilting movement of the workpiece.

A robot gripper according to the invention may comprise a plurality of suction units, e.g. two suction units. A first suction unit can be longer than a second suction unit with respect to a first direction. The suction surface of the first suction unit and the suction surface of the second suction unit are preferably in the same plane. The first and second suction units are preferably arranged side by side with respect to the first direction.

If a robot gripper comprises first and second suction units, as described above, the plurality of suction units can define a suction unit group. A robot gripper according to the invention may comprise a plurality, but preferably two, of these suction unit groups. Preferably, the suction surfaces of the suction units of the plurality of suction unit groups are in the same plane. Preferably, the suction unit groups are arranged side by side with respect to a second direction that is different from the first direction. The second direction can be perpendicular to the first direction.

If a robot gripper comprises a plurality of suction units, the robot gripper is preferably configured such that individual suction units or each individual suction unit can be selectively supplied with negative pressure.

A plurality of suction units can be associated with increased flexibility of the robot gripper. In particular if the suction units can be selectively supplied with negative pressure, such a robot gripper is suitable for removing plates of different dimensions. For instance, only one of the suction units of the robot gripper, namely a suction unit with a small suction surface, can be supplied with negative pressure in order to remove a small workpiece from a stack. However, another suction unit of the robot gripper, namely a suction unit with a larger suction surface, can also be supplied with negative pressure in order to remove a larger workpiece from a stack. In addition, a plurality of suction units of a robot gripper can also be simultaneously supplied with negative pressure in order to remove a very large workpiece from a stack.

A robot gripper according to the invention can be configured to tilt the suction unit relative to the receiving area by an angle of between 0.1° and 35° inclusive. Preferably, a robot gripper according to the invention is configured to tilt the suction unit relative to the receiving area by an angle of between 0.5° and 10° inclusive. Particularly preferably, a robot gripper according to the invention is configured to tilt the suction unit relative to the receiving area by an angle of between 1° and 2° inclusive.

It has been shown that the above-mentioned intervals are particularly suitable for picking up a plate-shaped workpiece in a process-safe manner and at the same time preventing that a workpiece located underneath adheres to the workpiece to be removed.

With a robot gripper according to the invention, the pressing edge may be an edge extending substantially parallel to the first tilt axis. For instance, the pressing edge may be an edge that is formed between the suction surface and a lateral surface of the suction unit and extends substantially parallel to the first tilt axis. Preferably, the pressing edge is provided with a radius smaller than or equal to 10 mm, and particularly preferably with a radius smaller than or equal to 1 mm. For example, the radius is in a range of between 0.2 mm and 1 mm inclusive.

If a pressing edge is provided with a radius, this can have an advantageous effect on possible interactions with the workpiece to be removed. Specifically, a radius is conducive to the damage-free removal of the workpiece.

However, the pressing edge may also be an element that is not directly connected to the suction surface of a suction unit. For example, a pressing edge may be an element that is attached to the receiving area of the robot gripper or to another structural element thereof. Moreover, a robot gripper may have a plurality of pressing edges.

Furthermore, a robot gripper according to the invention may comprise an identification system configured to read data from an identification means of a workpiece. An identification means may be a barcode, a QR code, an RFID tag, or a comparable identification means, for example. In this way, it can be made possible for a production control system, for example an IVIES system, to plan upcoming production steps and/or to monitor the production process.

A robot gripper according to the invention may comprise a recognition system configured to recognize the size and/or position of workpieces and/or workpiece edges. For example, the robot gripper may be configured to recognize the size and/or position of workpieces and/or workpiece edges by means of an optical image recognition system. Alternatively or additionally, the robot gripper may be configured to determine the size and/or position of workpieces and/or workpiece edges by means of the identification means and/or by means of data provided by a central device.

Using such a recognition system, the position of workpiece edges can be detected with a relatively high degree of accuracy, allowing the pressing edge of the robot gripper to be placed relatively accurately on a workpiece edge. A relatively accurate placing of the pressing edge of the robot gripper on a workpiece edge is in turn conducive to process-safe removal of the workpiece to be removed from the stack.

A robot gripper according to the invention may be configured to recognize whether the pressing edge is in contact with an object. Preferably, the robot gripper is also configured to obtain information on the pressing force resulting from the contact. Thus, firstly, a certain pressure can be created on the workpiece edge, which is necessary for removing the workpiece. Secondly, the workpiece can thus be protected from damage, e.g. due to an increased pressing force.

With a robot gripper according to the invention, the actuator may be pretensioned to a first zero position with a spring element, and the actuator may be configured to perform a discrete stroke opposite to the pretension when pressurized. In this way, a simple structure and a simple control of the robot gripper can be made possible. Specifically, with this robot gripper, a second pressurization is not necessary to bring the actuator from a stroke state into its zero position. Rather, it is sufficient to remove the pressurization with which the actuator performs a stroke opposite to the pretension. The spring element mentioned above may be, for example, a torsion spring, a coil spring, a bending spring or a gas pressure spring.

The robot gripper described above can comprise at least two serially connected actuators, wherein each of the at least two serially connected actuators is configured to perform a discrete stroke opposite to the pretension when pressurized, and wherein the robot gripper is configured such that each of the at least two serially connected actuators can be selectively pressurized. In this manner, a cost-effective robot gripper can be provided, in which the suction surface of the suction unit may take different tilt angles. The robot gripper can thus be used flexibly for different workpiece types and workpiece sizes.

Furthermore, one of the aforementioned robot grippers can comprise at least two actuators arranged in parallel, wherein each of these at least two actuators is configured to perform a discrete stroke opposite to the pretension when pressurized, and wherein the robot gripper is configured such that each of the at least two actuators connected in parallel can be selectively pressurized. In this manner, it can be made possible to tilt the suction surface of the suction unit in a first direction and/or in a second direction. The first direction and the second direction may be opposite directions. Consequently, the flexibility of the robot gripper can be further increased.

Furthermore, a robot gripper according to the invention can be configured such that the at least one suction unit can be tilted about a second axis, wherein the suction unit is pretensioned to a second zero position with respect to the second axis, the second axis being different from the first axis. Preferably, the second axis is perpendicular to the first axis. Moreover, the second axis is preferably parallel to the first direction. With such a robot gripper, it can be made possible to remove a workpiece from a stack, which lies on the stack at an angle with respect to the horizontal plane. The horizontal plane is a plane with respect to which the direction of gravity is perpendicular. Moreover, such a robot gripper can be used to remove workpieces from a stack which do not have a constant thickness.

An industrial robot according to the invention is configured as a linear robot with at least two, but preferably three, purely translatory degrees of freedom and with no more than two rotatory degrees of freedom. The industrial robot according to the invention is provided with one of the robot grippers described above.

An advantage of the invention lies in the interaction of the industrial robot according to the invention with the robot gripper. Since the actuator for tilting the suction surface is integrated in the robot gripper, a cost-effective linear robot can be used instead of a cost-intensive six-axis robot.

A method according to the invention for removing plate-shaped workpieces, which preferably consist at least in sections of wood, wood materials, plastic, aluminum or the like, from a stack comprises the following steps:
moving a previously described robot gripper into the vicinity of a workpiece to be removed, wherein the workpiece to be removed preferably lies between other workpieces;
tilting the suction unit such that the suction surface assumes an angle of between 0.1° and 35° inclusive, preferably between 0.5° and 10° inclusive, and particularly preferably between 1° and 2° inclusive, relative to the workpiece to be removed;
moving the robot gripper such that the pressing edge of the robot gripper lies substantially on an edge of the workpiece to be removed;
applying negative pressure to the suction unit such that the workpiece to be removed is pulled to the suction surface of the suction unit;
lifting the robot gripper together with the workpiece to be removed held on the suction surface.

A method according to the invention can moreover comprise the step of tilting back the suction unit, together with the workpiece to be removed.

Preferably, the method according to the invention is carried out with the industrial robot according to the invention.

The method according to the invention can be assigned the same and/or comparable advantages as the previously described robot gripper or industrial robot.

Preferably, the method step of applying negative pressure to the suction unit is carried out after the step of tilting the suction unit. In this way, the risk of also sucking further workpieces that are arranged under the workpiece to be removed is minimized.

A method according to the invention can further comprise the following step: detecting the size of the workpiece using a recognition system configured to detect the position of the edges of the workpiece, and/or using an identification system configured to read the size of the workpiece from an identification means assigned to the workpiece, wherein the identification means is preferably a barcode, a QR code, or a comparable code.

Using such a recognition system, the position of workpiece edges can be detected with a relatively high degree of accuracy, allowing the pressing edge of the robot gripper to be placed relatively accurately on a workpiece edge. A relatively accurate placing of the pressing edge of the robot gripper on a workpiece edge is in turn conducive to process-safe removal of the workpiece to be removed from the stack.

In addition, a method according to the invention can comprise the following step: determining the position of the edge of a workpiece on the basis of the position of an identification means assigned to the workpiece, wherein the identification means is preferably a barcode, a QR code, or a comparable code.

The method described above may have cost advantages over other, comparable methods. For example, configurations are conceivable in which a system for determining the position of an identification means is more cost-effective than a direct system for determining the position of an edge of a workpiece. Moreover, an aforementioned method can be more accurate than a direct system for determining the position of an edge of a workpiece. The reason is that an identification means may be provided with reproducible landmarks, whereas edges of a workpiece may have a different appearance depending on the nature of the material.

Furthermore, a method according to the invention can comprise the following step:
selecting a suction unit suitable for the size of the workpiece to be removed; or selecting a combination of a plurality of suction units suitable for the size of the workpiece to be removed;
selectively supplying the selected suction unit or the selected suction units with negative pressure, wherein the non-selected suction units are not supplied with negative pressure.

The flexibility of the method according to the invention can be promoted by these additional method steps. Specifically, this also allows plates of different dimensions to be efficiently removed. For instance, only one of the suction units of the robot gripper, namely a suction unit having a small suction surface, can be supplied with negative pressure in order to remove a small workpiece from a stack. However, another suction unit of the robot gripper, namely a suction unit with a larger suction surface, can also be supplied with negative pressure in order to remove a larger workpiece from a stack. In addition, a plurality of suction units of a robot gripper can also be simultaneously supplied with negative pressure in order to remove a very large workpiece from a stack.

A handling system according to the invention comprises an industrial robot according to the invention and a measurement means. The handling system is configured to recognize whether a plurality of workpieces are held on a suction unit of the robot gripper. The measurement means is preferably an area scanner. The plurality of workpieces can be, for example, two plate-shaped workpieces that adhere to one another in the thickness direction of the workpieces due to adhesion effects and/or due to the suction effect of the robot gripper.

If another workpiece adheres to the underside of a workpiece to be removed, there is the risk that this workpiece falls down in an uncontrolled manner during handling. This can disrupt the further removal routine, for example. Furthermore, there is also the risk that workpieces falling down may injure persons or damage plant components. If, however, it is recognized whether a plurality of workpieces are held on a suction unit, the specific removal process can be stopped and/or reversed, for example. Alternatively or additionally, a machine operator can be called to rectify the fault. Therefore, the handling system according to the invention can be associated with the effect of improving the efficiency of the removal process, reducing the risk of injury to persons and/or protecting plant components from damage.

### BRIEF DESCRIPTION OF THE FIGURES

FIG. 1 shows a perspective view of a storage device with a chaotic stack;

FIG. 2 is a schematic illustration of a first embodiment of a robot gripper according to the invention;

FIG. 3a is a schematic illustration of a second embodiment of a robot gripper according to the invention in a first state;

FIG. 4a is a schematic illustration of a third embodiment of a robot gripper according to the invention;

FIG. 4b is a schematic sectional view of the third embodiment of a robot gripper according to the invention along line A-A in FIG. 4a;

FIG. 5a schematically shows a step of an embodiment of a method according to the invention for removing plate-shaped workpieces from a stack;

FIG. 5b schematically shows a further step of an embodiment of a method according to the invention for removing plate-shaped workpieces from a stack;

FIG. 5c schematically shows a further step of an embodiment of a method according to the invention for removing plate-shaped workpieces from a stack;

FIG. 5d schematically shows a further step of an embodiment of a method according to the invention for removing plate-shaped workpieces from a stack.

### DETAILED DESCRIPTION OF PREFERRED EMBODIMENTS

The preferred embodiments of the present invention described below are merely examples, and should not be seen as limiting. Identical reference numbers specified in different figures designate identical, corresponding, or functionally similar elements.

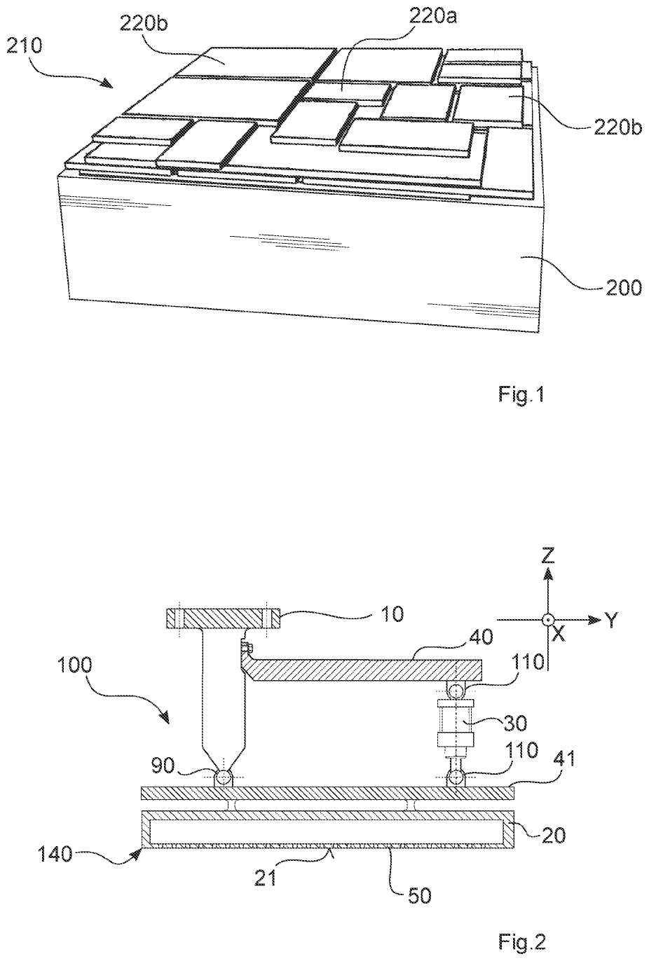

FIG. 1 shows a chaotic stack 210 lying on a storage device 200. The chaotic stack 210 comprises individual layers with workpieces 220, the individual layers differing in composition and/or arrangement. In the illustrated case, the chaotic stack 210 consists exclusively of plate-shaped workpieces 220. However, it is also conceivable that the chaotic stack alternatively or additionally comprises deviating workpiece types, for example bar-shaped workpieces. The chaotic stack 210 may also comprise workpieces of non-constant thickness, for example wedge-shaped workpieces and/or workpieces of any shape. The storage device 200 may be, for example, a pallet, or a parts carrier for an automated guided vehicle (AGV). The chaotic stack 210 shown in FIG. 1 comprises workpieces 220b lying in an edge section of the chaotic stack 210. In addition, the chaotic stack 210 shown in FIG. 1 comprises workpieces 220a lying in a central section of the chaotic stack 210. The workpieces 220 of the chaotic stack 210 shown in FIG. 1 have different dimensions.

FIG. 2 schematically shows a first embodiment of a robot gripper according to the invention. The robot gripper 100 comprises a receiving area 10 configured to be connected to an industrial robot 300. In addition, the robot gripper 100 comprises at least one suction unit 20 configured to be connected to a vacuum source. The suction unit 20 comprises a suction surface 21 on which a preferably plate-shaped workpiece, which preferably consists at least in sections of wood, wood materials, plastic, aluminum or the like, can be held by negative pressure. In addition, the robot gripper 100 comprises a substantially straight pressing edge 140 in an edge section. The robot gripper 100 further comprises an actuator 30 configured to tilt the suction unit 20 about a first tilt axis relative to the receiving area 10.

In the first embodiment shown, the tilt axis is the axis of a joint 90. The tilt axis is parallel to the X direction. The actuator 30 is a cylinder, for example a hydraulically or pneumatically operable cylinder. The actuator 30 is connected to a first support element 40 via a joint 110, and via a further joint 110 to a second support element 41. The first support element 40 is connected to the receiving area 10 without a degree of freedom. The second support element 41 is connected to the receiving area 10 via a joint 90. The suction unit 20 is attached to the second support element 41. In the present case, the suction unit 20 is configured as a suction box 20 that has suction openings 50 on its underside. The suction openings 50 are in fluidic connection with a space inside the suction box 20. The space inside the suction box in turn can be fluidically connected to a vacuum source (not shown).

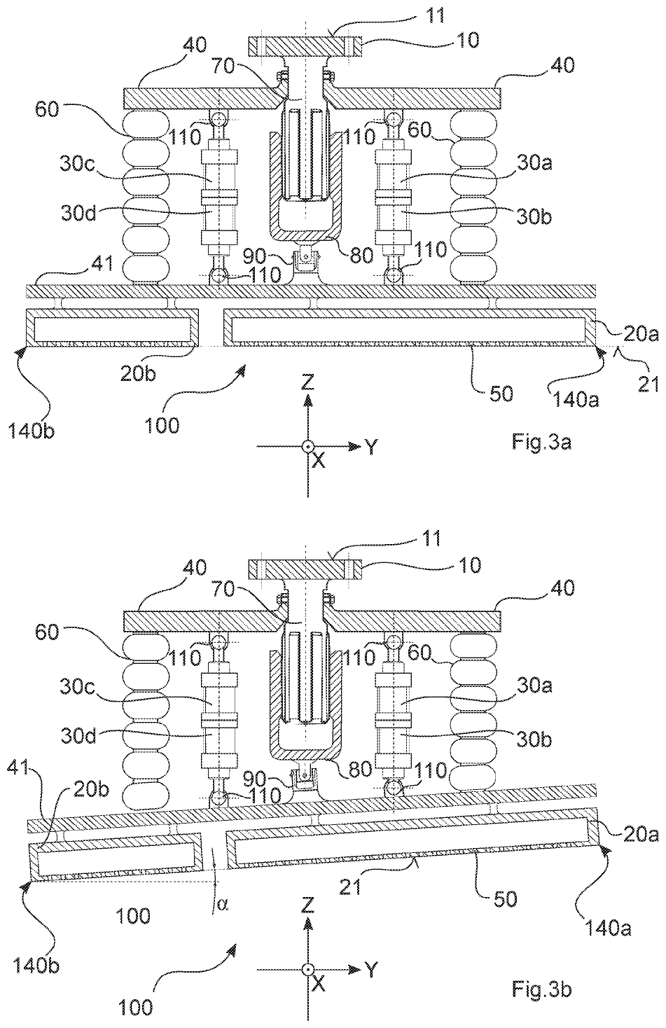

FIGS. 3a and 3b show a schematic illustration of a second embodiment of a robot gripper 100 according to the invention. The robot gripper 100 of the second embodiment comprises a receiving area 10 configured to be connected to an industrial robot 300. Furthermore, the robot gripper 100 comprises at least two suction units 20a, 20b, each configured to be connected to a vacuum source. The suction units 20a, 20b each comprise a suction surface 21 on which a preferably plate-shaped workpiece 220, which preferably consists at least in sections of wood, wood materials, plastic, aluminum or the like, can be held by negative pressure. The robot gripper 100 of the second embodiment comprises a substantially straight pressing edge 140a in a first edge section, and a substantially straight pressing edge 140b in a second edge section. The robot gripper 100 of the second embodiment further comprises at least four actuators 30a, 30b, 30c, 30d configured to tilt the suction units 20a, 20b about a first tilt axis relative to the receiving area 10.

In the case shown, the first tilt axis is an axis that is parallel to the X direction. The first tilt axis may be, for example, an axis of the joint 90, an axis of a joint 110 of an actuator 30a, 30b, 30c, 30d, or an axis that is substantially coincident with one of the pressing edges 140a, 140b. In the robot gripper 100 of the second embodiment, the actuators are pretensioned to a first zero position with spring elements 60. The robot gripper 100 of the second embodiment further comprises at least four actuators 30a, 30b, 30c, 30d, with two of these actuators 30a, 30b and 30c, 30d each being serially connected. Each of the serially connected actuators 30a, 30b, 30c, 30d is configured to perform a discrete stroke opposite to the pretension when pressurized. The robot gripper 100 of the second embodiment is configured such that each of the actuators 30a, 30b, 30c, 30d can be selectively pressurized. The serially arranged actuators 30a, 30b are arranged parallel to the serially arranged actuators 30c, 30d. In this way, the robot gripper 100 can be tilted in two opposite directions. Due to the serial arrangement of the actuators 30a, 30b and 30c, 30d, respectively, it is possible for the suction units 20a, 20b or the suction surface 21 of the robot gripper 100 to assume at least four different tilt angles relative to the receiving area 10. The robot gripper of the second embodiment may comprise spring elements 60 that are configured, for example, as gas pressure springs, torsion springs, bending springs, or the like. The variant of the second embodiment shown in FIGS. 3a and 3b comprises gas pressure springs 60.

As shown in FIGS. 3a and 3b, a suction unit 20a of the robot gripper 100 may be longer in a first direction, in the present case the Y direction, than another suction unit 20b of the robot gripper 100. The suction units 20a, 20b of the robot gripper have a common, flat suction surface 21. In addition, the suction units are arranged side by side with respect to the first direction, in the present case with respect to the Y direction. In the present case, the suction units 20a, 20b are configured as suction boxes 20a, 20b which have suction openings 50 on their underside. The suction openings 50 are each in fluidic connection with spaces inside the suction boxes 20a, 20b. The spaces inside the suction boxes 20a, 20b in turn can be fluidically connected to a vacuum source (not shown). Each space inside a suction box 20a, 20b can be selectively fluidically connected to a vacuum source (not shown).

The actuators 30a, 30c are each attached to a first support element 40 by a joint 110. The actuators 30b, 30d are each attached to a second support element 41 by a joint 110. The suction units 20a, 20b are attached to the second support element 41. The first support element 40 is connected to the receiving area 10 without a degree of freedom. The second support element 41 is connected to a spline shaft hub 80 via the joint 90. The spline shaft hub 80 engages a spline shaft 70 which in turn is connected to the receiving area 10 without a degree of freedom. The receiving area 10 has a receiving surface 11.

The embodiment shown with a spline shaft 70 and a spline shaft hub 80 is advantageous in that suction units 20a, 20b can be set to a plurality of different tilt angles with few actuators 30a, 30b, 30c, 30d. In addition, the system, consisting of spline shaft 70 and spline shaft hub 80, secures the suction units 20a, 20b against transverse forces (in the case shown: forces in the X direction and in the Y direction) and against torsion with respect to the spline shaft axis (in the case shown: torsion with respect to the Z axis).

The states of the robot gripper 100 of the second embodiment shown in FIGS. 3a and 3b differ solely by the tilt angle α, by which the suction units 20a, 20b, or their suction surface 21, are tilted relative to the receiving area 10 that has a receiving surface 11. Specifically, FIG. 3a shows a state in which the suction surface 21 of the robot gripper 100 is oriented substantially parallel to the receiving surface 11 of the receiving area 10. FIG. 3b, on the other hand, shows a state in which the suction surface 21 of the robot gripper 100 assumes an angle α relative to the receiving surface 11 of the receiving area 10. For example, the angle α can assume a value of between 0.1° and 35° inclusive. Preferably, the angle α assumes a value of between 0.5° and 10° inclusive, and particularly preferably between 1° and 2° inclusive.

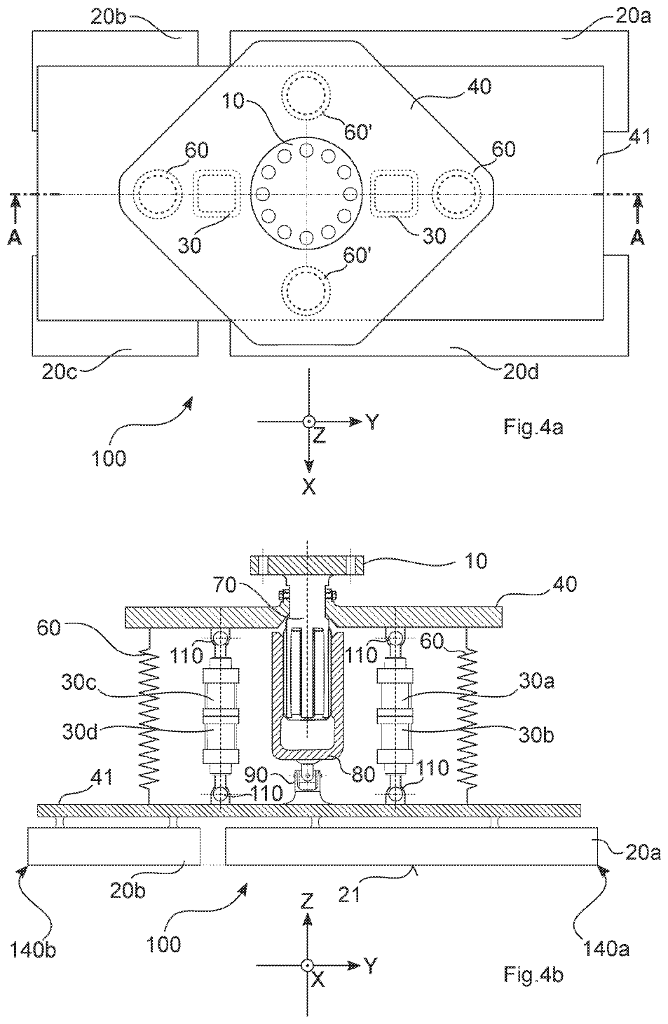

FIG. 4a shows a schematic top view of a third embodiment of a robot gripper 100 according to the invention. FIG. 4b shows a schematic sectional view of the third embodiment along line A-A in FIG. 4a. The third embodiment of the robot gripper 100 substantially corresponds to the second embodiment described above. However, the third embodiment of the robot gripper 100 comprises a plurality, but preferably two, groups of suction units. In the case shown, the suction units 20a, 20b form a first suction unit group. The suction units 20c, 20d form a second suction unit group (cf. FIG. 4a). The suction surfaces 21 of the suction units of the suction unit groups lie in the same plane. The suction unit groups are arranged side by side with respect to a second direction that is different from the first direction. In the case shown, the second direction is the X direction.

The robot gripper 100 of the second embodiment is configured such that individual suction units 20a, 20b, 20c, 20d can be selectively supplied with negative pressure. The robot gripper 100 of the third embodiment is also configured such that individual combinations of suction units, for example the suction units 20b and 20c, can be supplied with negative pressure.

The robot gripper 100 of the third embodiment is suitable for removing plates 220 of different dimensions from a chaotic stack 210. For instance, only one of the suction units 20a, 20b, 20c, 20d of the robot gripper 100, e.g. suction unit 20b, can be supplied with negative pressure in order to remove a small workpiece from a stack. However, another one of the suction units 20a, 20b, 20c, 20d of the robot gripper 100, e.g. the suction unit 20a, can also be supplied with negative pressure in order to remove a larger workpiece 220 from a chaotic stack 210. In addition, a plurality or all of the suction units 20a, 20b, 20c, 20d of a robot gripper 100 can also be simultaneously supplied with negative pressure in order to remove a very large workpiece 220 from a chaotic stack 210.

The robot gripper 100 of the third embodiment is configured such that the suction units 20a, 20b, 20c, 20d can be tilted about a second axis. In the case shown, the second axis is the Y axis. The suction units 20a, 20b, 20c, 20d are pretensioned to a second zero position with respect to the second axis. Pretensioning is performed with spring elements 60′ (cf. FIG. 4a). Both the tilting about the first axis and the tilting about the second axis can be realized withe the joint 90. The joint 90 may be configured as a universal joint for this purpose.

Thus, a robot gripper 100 of the third embodiment can be used to remove workpieces 220 from a chaotic stack 210 which lie on the chaotic stack 210 at an angle with respect to the horizontal plane. The horizontal plane is a plane with respect to which the direction of gravity is perpendicular. In the case shown, the horizontal plane is the XY plane. In addition, a robot gripper 100 of the third embodiment can be used to remove workpieces 220 from a chaotic stack 210 which do not have a constant thickness.

The spring elements 60 of the robot gripper 100 of the third embodiment are schematically shown as coil springs in FIG. 4b. However, a robot gripper 100 of the third embodiment may alternatively or additionally comprise any other types of springs, for example, torsion springs, bending springs, or gas pressure springs. The same applies to the spring elements 60′.

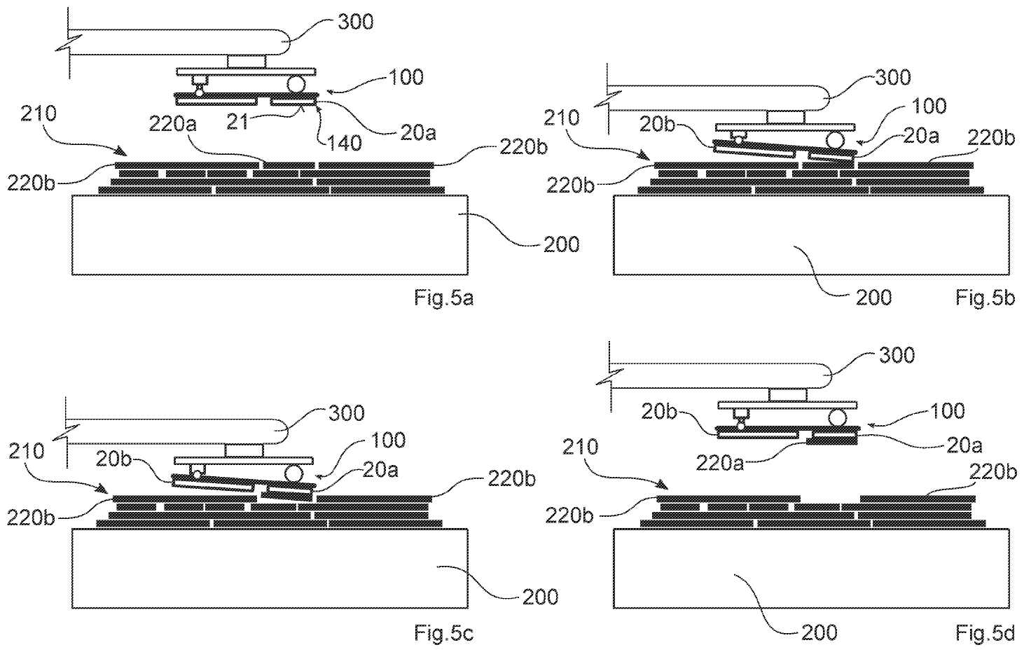

FIGS. 5a to 5d schematically show steps of an embodiment of a method according to the invention for removing plate-shaped workpieces 220 from a chaotic stack 210. FIG. 5a schematically shows the step of moving a robot gripper 100, which is attached to an industrial robot 300, into the vicinity of a workpiece 220a to be removed. The workpiece 220a to be removed is substantially centered on the uppermost layer of a chaotic stack 210 between workpieces 220b lying in edge sections of the uppermost layer of the chaotic stack 210. The robot gripper 100 shown comprises at least one suction unit 20a. For example, the robot gripper 100 shown may be a robot gripper 100 of the first, second, or third embodiments. The workpieces of the chaotic stack 210 lie on a storage device 200.

FIG. 5b shows a state of the robot gripper 100 attached to the industrial robot 300, of the storage device 200 and of the chaotic stack 210 after the following method steps have been carried out: tilting the suction unit 20a such that the suction surface 21 assumes an angle of between 0.1° and 35° inclusive, preferably between 0.5° and 10° inclusive, and particularly preferably between 1° and 2° inclusive, relative to the workpiece 220a to be removed; moving the robot gripper 100 such that the pressing edge 140 of the robot gripper lies substantially on an edge of the workpiece 220a to be removed.

FIG. 5c shows a state of the robot gripper 100 attached to the industrial robot 300, of the storage device 200 and of the chaotic stack 210 after the following method step has been carried out: applying negative pressure to the suction unit 20a such that the workpiece 220a to be removed is pulled to the suction surface 21 of the suction unit 20a.

FIG. 5d shows a state of the robot gripper 100 attached to the industrial robot 300, of the storage device 200 and of the chaotic stack 210 after the following method step has been carried out: lifting the robot gripper together with the workpiece to be removed held on the suction surface.

### REFERENCE NUMBERS

10 Receiving area
11 Receiving surface
20 Suction unit
21 Suction surface
30 Actuator
40 First support element
41 Second support element
50 Suction opening
60 Spring element
70 Spline shaft
80 Spline shaft hub
90 Joint
100 Robot gripper
110 Joint
140 Pressing edge
200 Storage device
210 Chaotic stack
220 Workpiece
220a Central workpiece
220b Workpiece in edge section
300 Industrial robot

1. Robot gripper having a receiving area which is configured to be connected to an industrial robot, and having at least one suction unit which is configured to be connected to a vacuum source, wherein the suction unit comprises a suction surface on which a preferably plate-shaped workpiece, which preferably consists at least in sections of wood, wood materials, plastic, aluminum or the like, can be held by means of negative pressure, and wherein the robot gripper comprises a substantially straight pressing edge in an edge section,
characterized in that
the robot gripper further comprises an actuator configured to tilt the suction unit about a first tilt axis relative to the receiving area.

2. Robot gripper according to claim 1, which comprises at least two suction units and in which a first suction unit is preferably longer than a second suction unit in a first direction, wherein the suction surface of the first suction unit and the suction surface of the second suction unit are in the same plane, and wherein the first and the second suction units are preferably arranged side by side with respect to the first direction.

3. Robot gripper according to claim 2, in which the first suction unit and the second suction unit define a suction unit group, wherein the robot gripper comprises a plurality, but preferably two, suction unit groups, wherein the suction surfaces of the suction units of the plurality of suction unit groups are in the same plane, and wherein the suction unit groups are arranged side by side with respect to a second direction that is different from the first direction and is preferably perpendicular to the first direction.

4. Robot gripper according to one of the preceding claims, in which each suction unit can be selectively supplied with negative pressure.

5. Robot gripper according to one of the preceding claims, which is configured to tilt the suction unit relative to the receiving area by an angle of between 0.1° and 35° inclusive, preferably between 0.5° and 10° inclusive, and particularly preferably between 1° and 2° inclusive.

6. Robot gripper according to one of the preceding claims, in which the pressing edge is an edge between the suction surface and a lateral surface of the suction unit, which extends substantially parallel to the first tilt axis, wherein the pressing edge is preferably provided with a radius smaller than or equal to 10 mm, and particularly preferably with a radius smaller than or equal to 1 mm.

7. Robot gripper according to one of the preceding claims, which further comprises an identification system configured to read data from an identification means of a workpiece.

8. Robot gripper according to one of the preceding claims, which further comprises a recognition system configured to recognize the size and/or position of workpieces and/or workpiece edges.

9. Robot gripper according to one of the preceding claims, which is configured to recognize whether the pressing edge is in contact with an object, and which is preferably configured to obtain information on the pressing force resulting from the contact.

10. Robot gripper according to one of the preceding claims, in which the actuator is pretensioned to a first zero position with a spring element, and in which the actuator is configured to perform a discrete stroke opposite to the pretension when pressurized.

11. Robot gripper according to claim 10, which comprises at least two serially connected actuators, wherein each of the at least two serially connected actuators is configured to perform a discrete stroke opposite to the pretension when pressurized, and wherein the robot gripper is configured such that each of the at least two serially connected actuators can be selectively pressurized.

12. Robot gripper according to one of claim 10 or 11, which comprises at least two actuators arranged in parallel, wherein each of these at least two actuators is configured to perform a discrete stroke opposite to the pretension when pressurized, and wherein the robot gripper is configured such that each of the at least two actuators connected in parallel can be selectively pressurized.

13. Robot gripper according to one of the preceding claims, which is configured such that the at least one suction unit can be tilted about a second axis, wherein the suction unit is pretensioned to a second zero position with respect to the second axis, the second axis being different from the first axis.

14. Industrial robot, configured as a linear robot with at least two, but preferably three, purely translatory degrees of freedom and with no more than two rotatory degrees of freedom, wherein the industrial robot is provided with a robot gripper according to one of the preceding claims.

15. Method for removing plate-shaped workpieces, which preferably consist at least in sections of wood, wood materials, plastic, aluminum or the like, from a stack, with the steps of:
moving a robot gripper according to one of claims 1 to 13 into the vicinity of a workpiece to be removed, wherein the workpiece to be removed preferably lies between other workpieces;
tilting the suction unit such that the suction surface assumes an angle of between 0.1° and 35° inclusive, preferably between 0.5° and 10° inclusive, and particularly preferably between 1° and 2° inclusive, relative to the workpiece to be removed;
moving the robot gripper such that the pressing edge of the robot gripper lies substantially on an edge of the workpiece to be removed;
applying negative pressure to the suction unit such that the workpiece to be removed is pulled to the suction surface of the suction unit;
lifting the robot gripper together with the workpiece to be removed held on the suction surface.

16. Method according to claim 15, with the additional step of: tilting back the suction unit, together with the workpiece to be removed.

17. Method according to claim 15 or 16, in which the step of applying negative pressure to the suction unit is carried out after the step of tilting the suction unit.

18. Method according to one of claims 15 to 17, with the additional step of: detecting the size of the workpiece using a recognition system configured to detect the position of the edges of the workpiece, and/or using an identification system configured to read the size of the workpiece from an identification means assigned to the workpiece, wherein the identification means is preferably a barcode, a QR code, or a comparable code.

19. Method according to one of claims 15 to 18, with the additional step of: determining the position of the edge of a workpiece on the basis of the position of an identification means assigned to the workpiece, wherein the identification means is preferably a barcode, a QR code, or a comparable code.

20. Method according to one of claim 18 or 19, with the additional steps of:
selecting a suction unit suitable for the size of the workpiece to be removed; or selecting a combination of a plurality of suction units suitable for the size of the workpiece to be removed;
selectively supplying the selected suction unit or the selected suction units with negative pressure, wherein the non-selected suction units are not supplied with negative pressure.

21. Handling system comprising an industrial robot according to claim 14 and a measurement means, wherein the handling system is configured to recognize whether a plurality of workpieces are held on a suction unit of the robot gripper, wherein the measurement means is preferably an area scanner.
